(19) United States
(12) Patent Application Publication
(10) Pub. No.: US 2006/0040666 A1
(43) Pub. Date: Feb. 23, 2006

(54) Mobile assisted handoff in wireless local area network

(76) Inventors: Murali Narasimha, Grayslake, IL (US); Sanjay Gupta, Lakewood, IL (US)

Correspondence Address: MOTOROLA INC, 600 NORTH US HIGHWAY 45, ROOM AS437, LIBERTYVILLE, IL, 60048-5343, US

(21) Appl. No.: 10/919,879

(22) Filed: Aug. 17, 2004

(51) Int. Cl. H04Q 7/20

(52) U.S. Cl. 455/436

(57) ABSTRACT

A method in a wireless communication device communicating in a wireless local area network, including determining, at layer 2 architecture of the wireless communication device, error information for a communication link between another device in the wireless local area network and the wireless communication device, and determining whether to handoff from the wireless local area network based on the error information for the communication link.

### FIELD OF THE DISCLOSURE

The present disclosure relates generally to wireless communications, and more particularly to in-call hand-off among different networks, for example, between a wireless local area network (WLAN) and a cellular communication network, communication networks and devices and corresponding methods.

### BACKGROUND OF THE DISCLOSURE

While wireless local area networks (LANs) are used primarily for packet data communications, the idea of carrying voice packets through packet data networks has been explored extensively and is known generally. Wireless LANs are often established for connectivity in environments where signal strength and the quality of cellular communication network coverage are not optimal, for example, within buildings and in underground complexes. Recently, the growing proliferation of wireless LANs has raised interest in providing wireless communication devices that can communicate in both conventional wireless cellular networks and in wireless LANs.

While the idea of communicating in wireless LANS and cellular communication networks is known generally, seamlessly interconnecting wireless local area networks (LANs) and cellular networks poses significant challenges. In voice call communications, for example, interoperability between LANs and cellular communication networks requires capabilities like roaming and handoff that are presently available only in cellular communication networks.

Wireless LANs, many of which operate pursuant to one of the IEEE 802.xx protocols on unlicensed radio spectrum, and cellular networks transmit data and access networks fundamentally differently. Handoff in cellular networks is initiated when base station signal quality drops below a threshold. In cellular networks, where forward and reverse link transmissions are on different frequencies, signal quality measurements are performed easily at the physical layer by directly measuring signal strength or by measuring signal to noise ratio (SNR) information. In a wireless LAN, where network devices share a common frequency, the transmission medium is allocated to only one transmitter at a time for varying durations through a random access procedure. In wireless LANS, signal strength measurements made by a mobile station (MS) will vary depending on the proximity of the entity transmitting within the WLAN. This makes it difficult to measure the quality of the link between the access point (AP) and the wireless communication device using physical layer processes, e.g., signal strength, SNR etc. typically used in cellular networks. These and other differences make for difficulty determining when to handoff from a wireless local area network to other networks like cellular networks.

The various aspects, features and advantages of the disclosure will become more fully apparent to those having ordinary skill in the art upon careful consideration of the following Detailed Description thereof with the accompanying drawings described below.

### BRIEF DESCRIPTION OF THE DRAWINGS

FIG. 1 illustrates an exemplary system of networks including a wireless local area network and a cellular wireless communication network.

FIG. 2 is an exemplary wireless communication device state diagram illustrating handoff determination.

FIG. 3 illustrates an exemplary process for handoff between a wireless local area network and a cellular communication network.

FIG. 4 illustrates structure for an exemplary wireless local area network message.

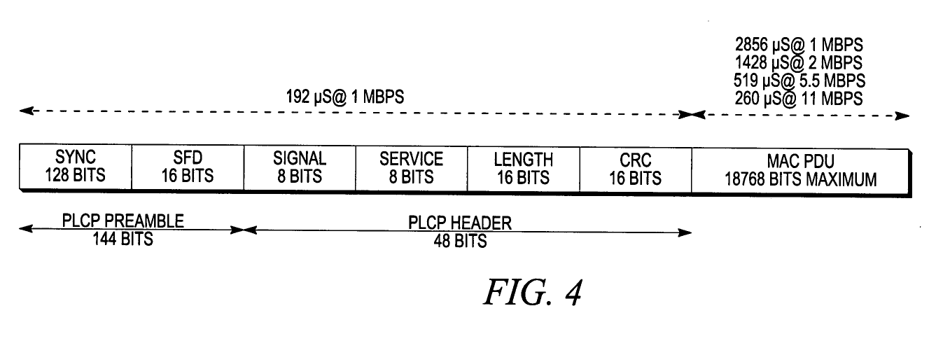

### DETAILED DESCRIPTION

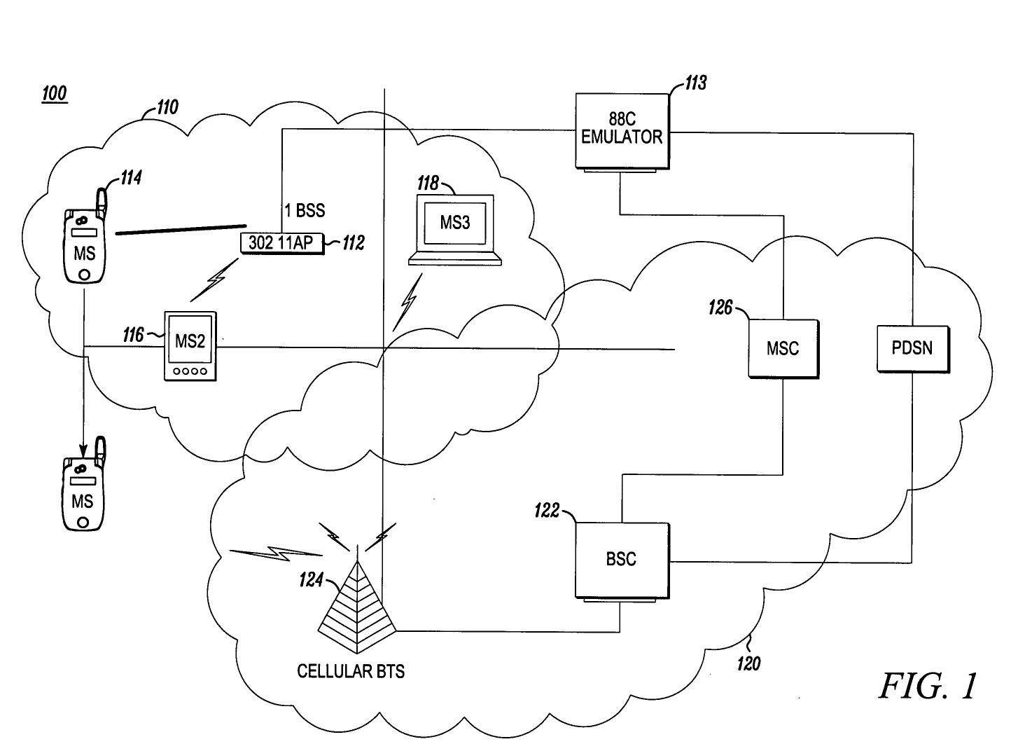

In FIG. 1, the exemplary system of networks 100 includes a wireless local area network (LAN) 110 comprising an access point 112 and first, second and third wireless communication devices 114,116 and 118. In the exemplary embodiment, the access point is an 802.11 compliant device, although in other applications it could operate pursuant to some other open or propriety communications protocol. The exemplary wireless LAN is a contentious communications environment where multiple devices, including the access point 112 and the wireless devices 114, 116, and 118 communicate on a common frequency. Generally, the wireless communication devices 114, 116 and 118 communicate with the access point 112, and/or with one another forming an adhoc network. More generally there may be multiple neighboring wireless LANs having corresponding access points with which mobile wireless communication devices may communicate.

The exemplary system of networks 200 also includes a cellular communication network 120 comprising a base station controller (BSC) 122 communicably coupled to one or more cellular base transceiver stations (BTS) 124. The cellular BSC 122 is also communicably coupled to a mobile switching center 126, which is communicably coupled to a public switched telephone network. The cellular BSC 122 is also communicably coupled to a packet data serving node (PDSN), which is communicably coupled to a packet network. Those having ordinary skill in the art are familiar with these and other aspects of cellular communication networks.

In FIG. 1, the wireless LAN, and particularly the exemplary access point 112, is communicably coupled to a base station controller (BSC) emulation entity 113. The BSC emulation entity 113 integrates with the cellular network mobile switching center (MSC) 126 and Packet Data Serving Node (PDSN) 128. The BSC emulation entity generally manages and provides access to mobile, voice and data services from various LAN locations, and facilitates automatic and seamless handover between radio access networks and wireless local area networks.

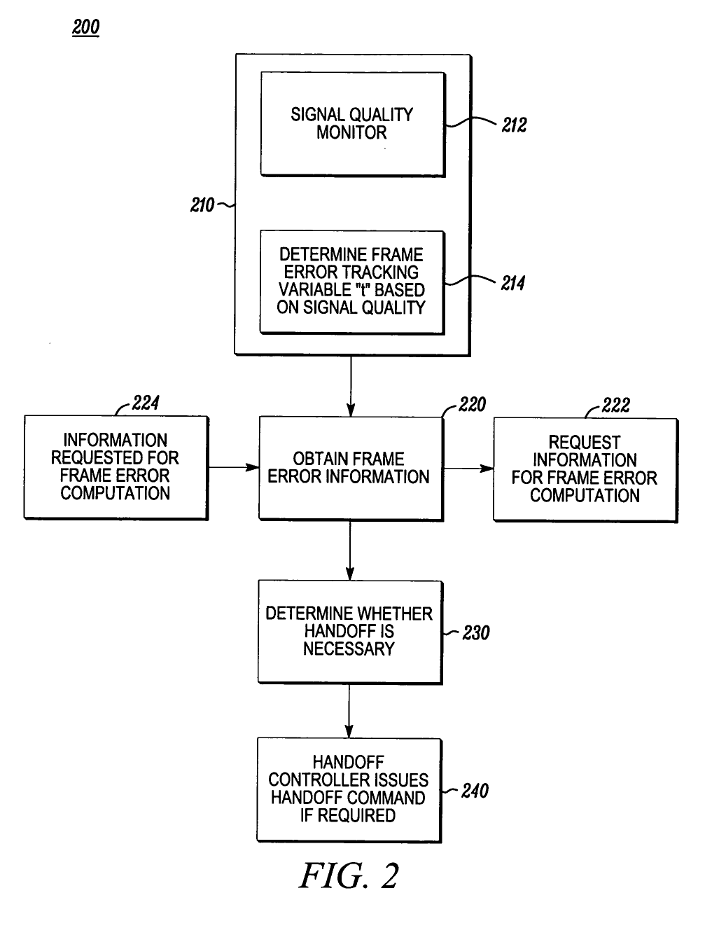

FIG. 2 is an exemplary wireless communication device state diagram 200 depicting determination of when to handoff from an access point in a wireless local area network to another network, for example, a cellular network. At logical block 210, the wireless communication device monitors signal quality, for example, by monitoring a received signal strength indication (RSSI) or a signal to noise ratio (SNR) or by some other process at the device physical layer at 212. At 214, the wireless device also determines a frame tracking variable “t” based on the monitored signal quality. Some communication protocols have signaling structures with variable frame sizes whereas other protocols have structures with fixed frame sizes. Thus in some embodiments, the frame tracking variable corresponds to a specified number of frames communicated between the access point and the wireless communication device. In other embodiments, the frame tracking variable is based on a fixed time duration or period or based upon some other characteristic associated with the communication link. Generally, better the signal quality requires less frame tracking, and worse signal quality requires more frame tracking, as will be more fully apparent from the discussion below.

In FIG. 2, at logical block 220, the wireless communication device obtains frame error information dependent upon the frame tracking variable discussed above. In one embodiment, the wireless communication device obtains uplink error and/or down link error information. In FIG. 2, at block 222, the wireless communication device requests from the access point information required for the wireless communication device to compute the frame error. At block 224, the access point provides the wireless communication device with information requested for the frame error computation. In one embodiment, the wireless communication device computes a frame error rate proportional to a ratio of the number of frames received correctly relative to a total number of frames tracked.

In the IEEE 802.11 wireless standard among other protocols, no part of the physical layer header identifies the originating device. Thus the origin of a particular frame can be determined at the medium access control (MAC) layer only if the frame is received correctly at the physical layer. Since it is not possible to determine the origin of frames received incorrectly, link quality, for example, the frame error rate between the wireless communication device and the access point, cannot be determined autonomously. In other words, in networks where the physical layer messaging information does not identify the source of the message, the total number of frames sent is known only by the source from where the frames originated unless the recipient device receives all frames without error.

To determine uplink frame error, for example, in 802.11 and like applications where physical layer header information does not identify the device originating the frames, it is necessary for the wireless communication device to indicate the number of frames that it sent to the access point. The access point may then determine the frame error rate based on the number of frames received correctly from the wireless communication device relative to the total number of frame sent by the wireless communication device over the tracking period or number of frames tracked, as indicated by the frame tracking variable.

Similarly, to determine the downlink frame error in 802.11 and like applications, it is necessary for the access point to indicate the total number of frames that it sent, i.e., to all devices, during the tracking period or during the number of frames tracked. The recipient device determines the downlink frame error rate based on the number of frames received correctly relative to the total number of frames sent.

In another embodiment, the request 222 from the wireless communication device includes, alternatively, information necessary for the access point to compute the uplink frame error. According to this alternative embodiment, the access point provides the uplink frame error information in the response at 224 instead of or in addition to any information that may be required for the wireless communication device to determine the downlink frame error.

In FIG. 2, at block 230, the wireless communication device determines whether handoff is necessary based on at least one of the uplink or downlink frame error information obtained at logical block 220. At block 240, the handoff request is communicated to the appropriate entity depending upon where the wireless communication device intends to handoff, for example, to an access point in another wireless local area network or to a base transceiver station (BTS) in a cellular communication network.

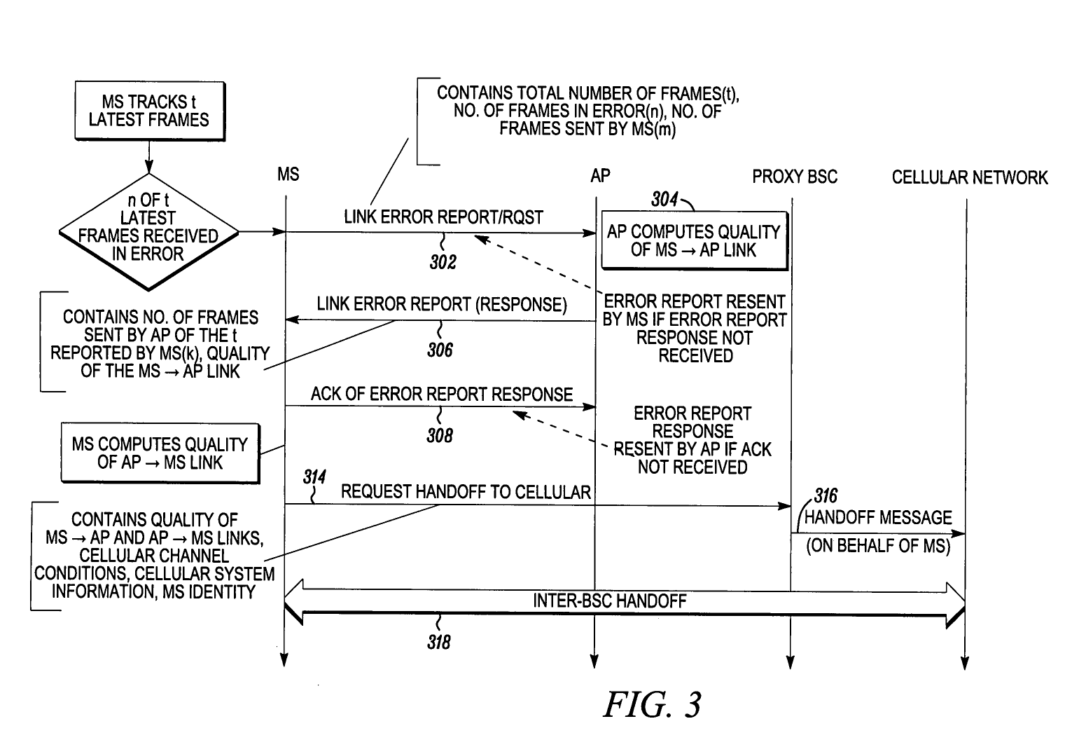

FIG. 3 illustrates an exemplary signaling diagram for an in-call handoff of a wireless communication device (MS) from a wireless local area network access point (AP) to a cellular communication network base station. The handoff may be during a voice call or during a data connection or some combination thereof. As discussed, the wireless communication device determines a frame tracking variable corresponding to the number of frames tracked or to the tracking duration, for example, based on a physical layer process or based on some other information. For the exemplary IEEE 802.11 protocol application, wherein the physical layer frame structure has variable bit numbers resulting in different size frames, the tracking variable is selected in terms of a predetermined number of frames.

In some embodiments, the wireless communication device, also referred to as a mobile station (MS), obtains link frame error information periodically, which maybe on a regular or an irregular basis. In other embodiments frame error information is obtained only when the signal quality measured at the physical layer satisfies a condition, for example, when a characteristic of the signal drops below a threshold. For example, the wireless communication device may enter a frame error monitoring mode where frame error information is obtained periodically whenever a signal quality condition measured at the physical layer is satisfied. Limiting the time during which frame error information is obtained reduces error report signaling between the wireless LAN and wireless communication device and also reduces power consumption in the wireless communication device.

In FIG. 3, the MS determines the number of frames “n”, of the latest “t” frames, received in error. In FIG. 3, at 302, the MS sends a link error report to the AP. The exemplary report includes the total number of frames “t”, the number of frames received in error “n”, and the number of frames sent by the MS to the AP. The inclusion of the number of frames sent by the MS to the AP enables the AP to compute the uplink frame error, as illustrated schematically at block 304.

In some embodiments, alternatively, the communication from the MS to the AP at 302 is a request for information required for the MS to compute the downlink frame error. Such a message may include the total number of frames “t”, and possibly the number of frames received in error “n” by the MS. In yet another embodiment, the communication from the MS to the AP at 302 is provides information sufficient for the AP to compute the uplink frame error. The latter exemplary message may include the total number of frames “t”, and the number of frames sent by the MS to the AP, “m”.

In FIG. 3, at block 306, the AP sends an error report to the MS. The exemplary report at 306 from the AP includes the number of frames sent by the AP to the MS of the “t” frames reported by the MS, and the uplink frame error. As suggested, however, in some embodiments, the communication 306 does not include the uplink error information, and in other embodiments the communication 306 does includes only the uplink error report information. At 308, the MS acknowledges receipt of the report from the AP, though in other embodiments the acknowledgement is not required.

At block 310, the MS determines the frame error for the downlink between the access point and the wireless communication device, for example, by computing a ratio of the number of frames received correctly by the MS from the AP relative to the total number of frames sent by the AP. In one embodiment, the wireless communication device makes the handoff determination by comparing the uplink and/or downlink frame error information to threshold information. Alternatively, the handoff determination or decision may be made on any other basis. In FIG. 3, if handoff from the access point is required or desired, at 314, the MS communicates the handoff request to the BSC emulation entity (proxy BSC). An exemplary handoff request from an access point to a cellular communication network includes a MS identity, cellular channel condition and system information obtained by the MS, and possible frame error information. At 316, the proxy BSC communicates with the cellular network, for example, with the MSC or PDSN in FIG. 1 depending on whether the call is a data or voice. Thereafter, at 318 in the exemplary embodiment, the MS engages in an inter-BSC handoff. More generally, the determination as to when to handoff from the access point is applicable to hand off to any other network. In embodiments where handoff is to an access point in another local area network, there would not be any communication with a proxy BSC as illustrated in the exemplary embodiment of FIG. 3.

While the present disclosure and what are presently considered to be the best modes thereof have been described in a manner establishing possession by the inventors and enabling those of ordinary skill in the art to make and use the same, it will be understood and appreciated that there are many equivalents to the exemplary embodiments disclosed herein and that modifications and variations may be made thereto without departing from the scope and spirit of the inventions, which are to be limited not by the exemplary embodiments but by the appended claims.

What is claimed is:

1. A method in a wireless local area network wherein multiple devices communicate on a common frequency, the method comprising:
obtaining uplink error information between a wireless communication device and an access point in the local area network;
obtaining downlink error information between the access point in the local area network and the wireless communication device;
determining whether to handoff the wireless communication device from the access point based on at least one of the uplink and downlink error information.

2. The method of claim 1,
obtaining the downlink error information based on a frame error rate between the access point and the wireless communication device,
obtaining the uplink error information based on a frame error rate between the wireless communication device and the access point.

3. The method of claim 2,
obtaining the uplink and downlink error information based on a frame error rate for a number of frames communicated between the wireless communication device and the access point.

4. The method of claim 3,
determining the number of frames based on signal quality information measured at the wireless communication device.

5. The method of claim 1, determining the uplink quality information at the access point.

6. The method of claim 1,
determining the downlink error information at the wireless communication device,
determining whether to handoff the wireless communication device at the wireless communication device.

7. The method of claim 1,
comparing at least one of the uplink and downlink error information to threshold information at the wireless communication station,
determining whether to handoff the wireless communication device from the access point based on comparing at least one of the uplink and downlink error information to the threshold information.

8. The method of claim 7,
sending a handoff request to an entity in the local area network based on at least one of the uplink and downlink error information.

9. The method of claim 1,
obtaining downlink error information between the access point in the local area network and the wireless communication device only when a signal quality condition monitored at a physical layer is satisfied.

10. A method in a wireless local area network including an access point, the method comprising:
determining uplink error information between a wireless communication device and the access point;
communicating the uplink error information to the wireless communication device.

11. The method of claim 10,
determining the uplink error information based on a number of frames received correctly by the access point from the wireless communication device relative to a total number of frames sent by the wireless communication device.

12. The method of claim 11,
receiving, at the access point, a message from the wireless communication device,
the message including the number of frames sent by the wireless communication device to the access point.

13. A method in a wireless communication device communicating in a wireless local area network, the method comprising:
determining layer 2 frame error information for a communication link between another device in the wireless local area network and the wireless communication device;
determining whether to handoff from the wireless local area network based on the frame error information for the communication link.

14. The method of claim 13,
determining the frame error information includes determining a downlink frame error between an access point of the wireless local area network and the wireless communication device;
determining whether to handoff from the access point based on the downlink frame error information.

15. The method of claim 14,
determining the downlink frame error information based on a number of frames received correctly by the wireless communication device from the access point relative to a total number of frames sent by the access point.

16. The method of claim 15,
receiving, at the wireless communication device, a message from the access point of the wireless local area network,
the message including the number of frames sent by the access point to the wireless communication device.

17. The method of claim 15,
receiving, at the wireless communication device, a message from the access point,
the message including frame error information for a communication uplink between the wireless communication device and the access point of the wireless local area network,
determining whether to handoff from the access point based on at least one of the frame error information for the communication downlink and the frame error information for the communication uplink.

18. The method of claim 13,
determining the frame error information for the communication link relative to a frame tracking variable based on signal quality information obtained at the wireless communication device.

19. The method of claim 13, determining whether to handoff during a call.

20. The method of claim 13, determining frame error information for a communication link between another device in the wireless local area network and the wireless communication device only when a signal quality condition monitored at a physical layer is satisfied.

21. A method in a wireless communication device communicating in a wireless local area network, the method comprising:
determining, at a layer 2 of the wireless communication device, error information for a communication link between another device in the wireless local area network and the wireless communication device;
determining whether to handoff from the wireless local area network based on the error information for the communication link.

22. The method of claim 21, determining the error information for the communication link only when a signal condition monitored at a physical layer of the wireless communication device is satisfied.
